(19) United States
(12) Patent Application Publication
(10) Pub. No.: US 2024/0165512 A1
(43) Pub. Date: May 23, 2024

(54) TIPPING GIFT FOR GAMES

(71) Applicant: 17LIVE Japan Inc., Tokyo (JP)

(72) Inventors: Christopher PASLEY, Los Angeles, CA (US); Hao SUN, Taipei City (TW)

(21) Appl. No.: 18/348,773

(22) Filed: Jul. 7, 2023

Related U.S. Application Data
(60) Provisional application No. 63/426,468, filed on Nov. 18, 2022.

(30) Foreign Application Priority Data
Jan. 20, 2023 (JP) 2023-007325

(51) Int. Cl. A63F 13/533; A63F 13/5375; A63F 13/79

(52) U.S. Cl. CPC A63F 13/533; A63F 13/5375; A63F 13/79; A63F 13/87

(57) ABSTRACT

A terminal of a viewer of a livestream is provided that includes one or more processors and memory storing one or more computer programs configured to be executed by the one or more processors. The one or more computer programs include instructions for: communicating over a network with a server configured to provide a game, the game being playable within a livestream and involving gaining or losing points; and if points gained by the viewer by playing the game within the livestream satisfy a predetermined condition, starting to receive an instruction to use a gift to a livestreamer of the livestream.

### CROSS-REFERENCE TO RELATED APPLICATIONS

This application is based on and claims the benefit of priority from U.S. Provisional Patent Application No. 63/426,468 (filed on Nov. 18, 2022) and Japanese Patent Application Serial No. 2023-007325 (filed on Jan. 20, 2023), the contents of which are hereby incorporated by reference in its entirety.

### TECHNICAL FIELD

The present disclosure relates to a terminal, a method implemented on the terminal, and a server.

### BACKGROUND

With the development of IT technology, the way information is exchanged has changed. In the Showa period (1926-1989), one-way information communication via newspapers and television was the main stream. In the Heisei period (1990-2019), with the widespread availability of cell phones and personal computers, and the significant improvement in Internet communication speed, instantaneous interactive communication services such as chat services emerged, and on-demand video distribution services also become popular as storage costs were reduced. And nowadays, with the sophistication of smartphones and further improvements in network speed as typified by 5G, services that enable real-time communication through video, especially livestream services, are gaining recognition. The number of users of livestream services is expanding, especially among young people, as such services allow people to share fun moments even when they are in the separate locations from each other.

Games playable in a livestream are helpful to attract viewers. An exemplary game in a livestream is disclosed in FayBlog, “How To Get Diamonds in Uplive! Also Talk About Mini-Games!”, URL:https://fayevery.blog/uplive-diamond #index_id6.

The games described in the above-mentioned FayBlog, however, do not make full use of their feature of being playable within livestreams.

### SUMMARY

The present disclosure has been made in view of the above, and one object of the disclosure is to provide a technique for facilitating interactions between livestreamers and viewers through games provided within livestreams.

An aspect of the present disclosure provides a terminal of a viewer of a livestream. The terminal includes: one or more processors; and memory storing one or more computer programs configured to be executed by the one or more processors. The one or more computer programs include instructions for: communicating over a network with a server configured to provide a game, the game being playable within a livestream and involving gaining or losing points; and if points gained by the viewer by playing the game within the livestream satisfy a predetermined condition, starting to receive an instruction to use a gift to a livestreamer of the livestream.

In the terminal described above, the predetermined condition is satisfied if a value obtained as a result of totaling gained and lost points exceeds a threshold.

In the terminal described above, a plurality of different thresholds are set, and each threshold is associated with a gift having a corresponding price, and the starting includes inquiring, if a value obtained as a result of totaling gained and lost points exceeds a threshold, the viewer whether the viewer uses a gift having a price corresponding to the exceeded threshold.

In the terminal described above, the one or more computer programs further include instructions for: on reception of the instruction to use the gift, outputting an effect of the gift within the livestream and outside a user interface of the game.

In the terminal described above, the one or more computer programs further include instructions for outputting a message within the livestream if the points gained by the viewer by playing the game within the livestream satisfy the predetermined condition, the message indicating that the viewer has satisfied the predetermined condition, and the message is also output at a terminal of the livestreamer of the livestream and terminals of one or more other viewers.

In the terminal described above, the livestreamer of the livestream does not participate in the game.

Another aspect of the present disclosure provides a method implemented at a terminal of a viewer of a livestream. The method includes communicating over a network with a server configured to provide a game, the game being playable within a livestream and involving gaining or losing points; and if points gained by the viewer by playing the game within the livestream satisfy a predetermined condition, starting to receive an instruction to use a gift to a livestreamer of the livestream.

In the method described above, the predetermined condition is satisfied if a value obtained as a result of totaling gained and lost points exceeds a threshold.

In the method described above, a plurality of different thresholds are set, and each threshold is associated with a gift having a corresponding price, and the starting includes inquiring, if a value obtained as a result of totaling gained and lost points exceeds a threshold, the viewer whether the viewer uses a gift having a price corresponding to the exceeded threshold.

In the method described above, the method further comprises on reception of the instruction to use the gift, outputting an effect of the gift within the livestream and outside a user interface of the game.

In the method described above, the method further comprises outputting a message within the livestream if the points gained by the viewer by playing the game within the livestream satisfy the predetermined condition, the message indicating that the viewer has satisfied the predetermined condition. The message is also output at a terminal of the livestreamer of the livestream and terminals of one or more other viewers.

In the method described above, the livestreamer of the livestream does not participate in the game.

Another aspect of the present disclosure provides a server including

a unit for providing a game to a terminal of a viewer of a livestream via a network, the game being playable within the livestream and involving gaining and losing points; a unit for determining whether points gained by the viewer by playing the game within the livestream satisfy a predetermined condition; a unit for, if the predetermined condition is determined to be satisfied, transmitting a request via the network to the terminal of the viewer, the request being configured to allow the terminal of the viewer to start receiving an instruction to use a gift for a livestreamer of the livestream; and a unit for, when the instruction to use the gift is received, transmitting via the network a request to a terminal of the livestreamer and terminals of one or more other viewers, the request being configured to cause an effect of the gift to be output outside a user interface of the game.

The server described above further includes: a unit for, when the instruction to use the gift is received, registering in a holding unit information relating to the gift; and a unit for consulting the holding unit to generate a leaderboard ranking livestreamers according to gifts sent to the livestreamers and/or a leaderboard ranking viewers according to gifts the viewers send.

It should be noted that the components described throughout this disclosure may be interchanged or combined. The components, features, and expressions described above may be replaced by devices, methods, systems, computer programs, recording media containing computer programs, etc. Any such modifications are intended to be included within the spirit and scope of the present disclosure.

The aspects of the disclosure can contribute to facilitate interaction between livestreamers and viewers through games provided within livestreams.

### BRIEF DESCRIPTION OF THE DRAWINGS

FIG. 1 schematically illustrates a configuration of a livestreaming system according to one embodiment of the disclosure.

FIG. 2 is a block diagram showing functions and configuration of a user terminal shown in FIG. 1.

FIG. 3 is a block diagram showing functions and configuration of a server shown in FIG. 1.

FIG. 4 is a data structure diagram showing, as an example, a stream DB shown in FIG. 3.

FIG. 5 is a data structure diagram showing, as an example, a user DB shown in FIG. 3.

FIG. 6 is a data structure diagram showing, as an example, a gift DB shown in FIG. 3.

FIG. 7 is a data structure diagram showing, as an example, a game results DB shown in FIG. 3.

FIG. 8 is a flow chart showing processes performed in the livestreaming system when a viewer plays a game in a livestream.

FIG. 9 is a representative screen image of a livestreaming room screen appearing on the display of a viewer's user terminal.

FIG. 10 is a representative screen image of the livestreaming room screen having a game region superimposed thereon, which appears on the display of the viewer's user terminal.

FIG. 11 is a representative screen image of the livestreaming room screen having the game region superimposed thereon, which appears on the display of the viewer's user terminal.

FIG. 12 is a representative screen image of the livestreaming room screen with a tip request region, which is shown on the display of the viewer's user terminal.

FIG. 13 is a representative screen image of the livestreaming room screen with the game region and tipping gift effects, which is shown on the display of the viewer's user terminal.

FIG. 14 is a block diagram showing an example of a hardware configuration of the information processing device according to the embodiment.

FIG. 15 is a representative screen image of a livestreaming room screen with a game region 692 having a tip placement region, which is shown on the display of the viewer's user terminal.

FIG. 16 is a data structure diagram showing, as an example, a tipping gift setting DB shown in FIG. 3.

FIG. 17 is a representative screen image of a leaderboard screen displayed on the display of the viewer's user terminal.

### DESCRIPTION OF THE PREFERRED EMBODIMENTS

Like elements, components, processes, and signals throughout the Figures are labeled with same or similar designations and numbering, and the description for the like elements will not be hereunder repeated. For purposes of clarity and brevity, some of the components that are less related and thus not described are not shown in Figures.

In the prior art, viewers who play a game (hereinafter simply referred to as “game”) which is playable in a livestream and which is associated with profit/loss of points may receive benefit from the results of the game if they win; however, a livestreamer distributing the livestream does not have any direct benefit from the game. In the embodiment below, a system is provided where a tipping mechanism is implemented. If a viewer wins in a game, the viewer is asked to give the livestreamer a “tip” gift to share the viewer's luck with the livestreamer. By doing so, interaction among the livestreamer and the viewers is enhanced. In particular, the embodiment helps the viewers to share their wining experience with the livestreamer by streamlining the flow of tipping.

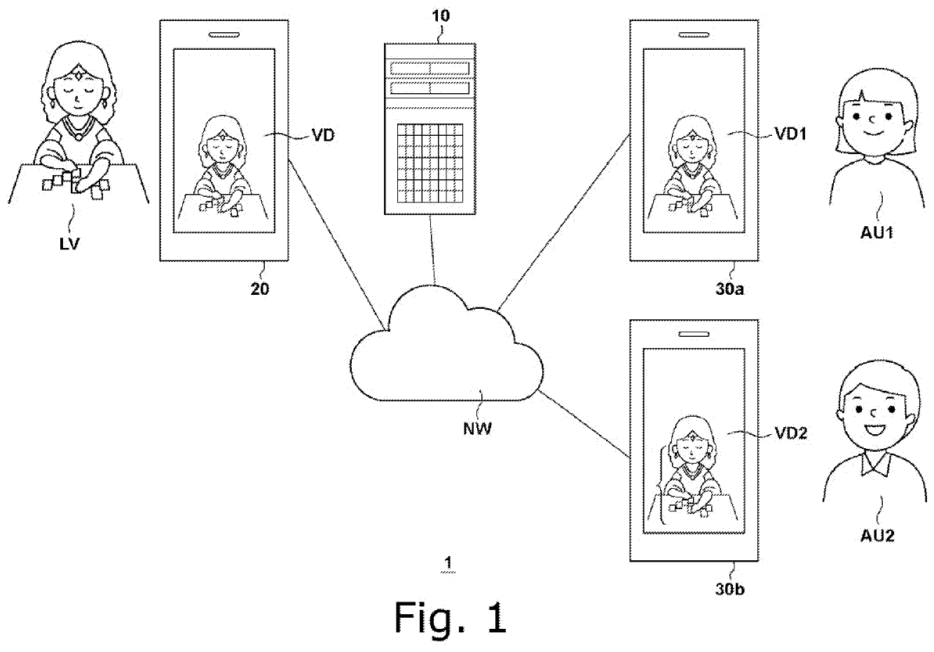

FIG. 1 schematically illustrates a configuration of a livestreaming system 1 according one embodiment of the disclosure. The livestreaming system 1 provides an interactive livestream service that allows a livestreamer LV (also referred to as a liver or streamer) and a viewer AU (also referred to as audience) (AU1, AU2 . . . ) to communicate in real time. As shown in FIG. 1, the livestreaming system 1 includes a server 10, a user terminal 20 on the livestreamer side, and user terminals 30 (30a, 30b . . . ) on the audience side. The livestreamer and viewers may be collectively referred to as users. The server 10 may be one or more information processing devices connected to a network NW. The user terminals 20 and 30 may be, for example, mobile terminal devices such as smartphones, tablets, laptop PCs, recorders, portable gaming devices, and wearable devices, or may be stationary devices such as desktop PCs. The server 10, the user terminal 20, and the user terminal 30 are interconnected so as to be able to communicate with each other over the various wired or wireless network NW.

The livestreaming system 1 involves the livestreamer LV, the viewers AU, and an administrator (not shown) who manages the server 10. The livestreamer LV is a person who broadcasts contents in real time by recording the contents with his/her user terminal 20 and uploading them directly to the server 1. Examples of the contents may include the livestreamer's own songs, talks, performances, fortune-telling, gameplays, and any other contents. In the embodiment, the livestreamer LV tells viewer AU's fortune in a livestream. The administrator provides a platform for livestreaming contents on the server 10, and also mediates or manages real-time interactions between the livestreamer LV and the viewers AU. The viewer AU accesses the platform at his/her user terminal 30 to select and view a desired content. During livestreaming of the selected content, the viewer AU performs operations to comment, cheer, or ask fortune-telling via the user terminal 30, the livestreamer LV who is delivering the content responds to such a comment, cheer, or request and such response is transmitted to the viewer AU via video and/or audio, thereby establishing an interactive communication.

The term “livestreaming” may mean a mode of data transmission that allows a content recorded at the user terminal 20 of the livestreamer LV to be played and viewed at the user terminals 30 of the viewers AU substantially in real time, or it may mean a live broadcast realized by such a mode of transmission. The livestreaming may be achieved using existing live delivery technologies such as HTTP Live Streaming, Common Media Application Format, Web Real-Time Communications, Real-Time Messaging Protocol and MPEG DASH. Livestreaming includes a transmission mode in which the viewers AU can view a content with a specified delay simultaneously with the recording of the content by the livestreamer LV. As for the length of the delay, it may be acceptable for a delay even with which interaction between the livestreamer LV and the viewers AU can be established. Note that the livestreaming is distinguished from so-called on-demand type transmission, in which the entire recorded data of the content is once stored on the server, and the server provides the data to a user at any subsequent time upon request from the user.

The term “video data” herein refers to data that includes image data (also referred to as moving image data) generated using an image capturing function of the user terminals 20 and 30, and audio data generated using an audio input function of the user terminals 20 and 30. Video data is reproduced in the user terminals 20 and 30, so that the users can view contents. In this embodiment, it is assumed that between video data generation at the livestreamer's user terminal and video data reproduction at the viewer's user terminal, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing. In other words, when video data is generated at the livestreamer's user terminal and then played back at the viewer's user terminal via the server 10, the video data generated at the livestreamer's user terminal, the video data that passes through the server 1, and the video data received and reproduced at the viewer's user terminal are all the same video data.

In the example in FIG. 1, the livestreamer LV is livestreaming his/her fortune telling. The user terminal 20 of the livestreamer LV generates video data by recording images and sounds of the livestreamer LV telling fortune, and the generated data is transmitted to the server 10 over the network NW. At the same time, the user terminal 20 displays a recorded video image VD of the livestreamer LV on the display of the user terminal 20 to allow the livestreamer LV to check the livestream currently performed.

The user terminals 30a and 30b of the viewers AU1 and AU2 respectively, who have requested the platform to view the livestream of the livestreamer LV, receive video data related to the livestream (may also be herein referred to as “livestreaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the livestreamer LV, and the audio outputted at the user terminals 30a and 30b is substantially the same as the audio recorded by the user terminal 20 of the livestreamer LV.

Recording of the images and sounds at the user terminal 20 of the livestreamer LV and reproduction of the video data at the user terminals 30a and 30b of the viewers AU1 and AU2 are performed substantially simultaneously. Once the viewer AU1 types a comment about the fortune told by the livestreamer LV on the user terminal 30a, the server 10 displays the comment on the user terminal 20 of the livestreamer LV in real time and also displays the comment on the user terminals 30a and 30b of the viewers AU1 and AU2, respectively. When the livestreamer LV reads the comment and develops his/her talk to cover and respond the comment, the video and sound of the talk are displayed on the user terminals 30a and 30b of the viewers AU1 and AU2, respectively. This interactive action is recognized as establishment of a conversation between the livestreamer LV and the viewer AU1. In this way, the livestreaming system 1 realizes the livestreaming that enables the interactive communication, not one-way communication.

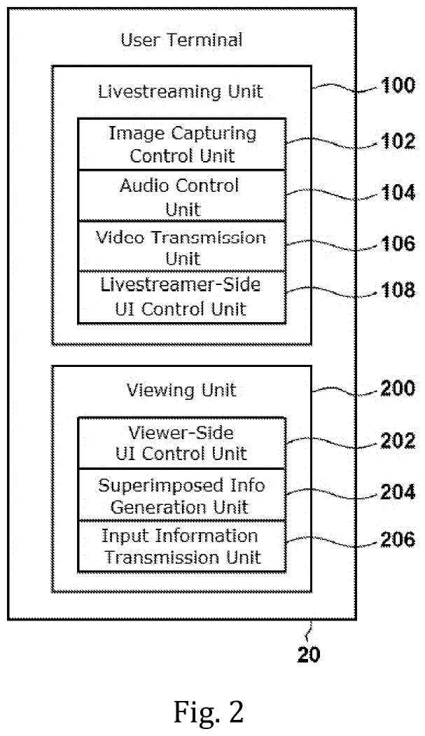

FIG. 2 is a block diagram showing functions and configuration of the user terminal 20 of FIG. 1. The user terminal 30 has the same functions and configuration as the user terminal 20. Each block in FIG. 2 and the subsequent block diagrams may be realized by elements such as a computer CPU or a mechanical device in terms of hardware, and can be realized by a computer program or the like in terms of software. Functional blocks are realized by cooperative operation between these elements. Therefore, it is understood by those skilled in the art that these functional blocks can be realized in various forms by combining hardware and software.

The livestreamer LV and the viewers AU download and install a livestreaming application program (hereinafter referred to as a livestreaming application) according to the embodiment to the user terminals 20 and 30 from a download site over the network NW. Alternatively, the livestreaming application may be pre-installed on the user terminals 20 and 30. When the livestreaming application is executed on the user terminals 20 and 30, the user terminals 20 and 30 communicate with the server 10 over the network NW to implement various functions. Hereinafter, the functions implemented by the user terminals 20 and 30 (processors such as CPUs) in which the livestreaming application is run will be described as functions of the user terminals 20 and 30. These functions are realized in practice by the livestreaming application on the user terminals 20 and 30. In any other embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 20 includes a distribution unit 100 that generates video data in which the user's image and sound are recorded and provides the video data to the server 10 and a viewing unit 200 to which the video data is provided from the server 10 to reproduce the video data. The user activates the distribution unit 100 when the user performs livestreaming, and activates the viewing unit 200 when the user views a video. The user terminal in which the distribution unit 100 is activated is the livestreamer's terminal, i.e., the user terminal that generates the video data, and the user terminal in which the viewing unit 200 is activated is the viewer's terminal, i.e., the user terminal in which the video data is reproduced and played.

The distribution unit 100 includes an image capturing control unit 102, an audio control unit 104, a video transmission unit 106, and a livestreamer-side UI control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The livestreamer-side UI control unit 108 controls an UI for the livestreamer. The livestreamer-side UI control unit 108 is connected to a display (not shown in FIG. 2), and displays a video on the display by reproducing the video data that is to be transmitted by the video transmission unit 106. The livestreamer-side UI control unit 108 displays an operation object or an instruction-accepting object on the display, and accepts inputs from the livestreamer who taps on the object.

The viewing unit 200 includes a viewer-side UI control unit 202, a superimposed information generation unit 204, and an input information transmission unit 206. The viewing unit 200 receives, from the server 10 over the network NW, the video data related to the livestream in which the livestreamer and viewers participate. The viewer-side UI control unit 202 controls the UI for the viewers. The viewer-side UI control unit 202 is connected to a display and speaker (not shown in FIG. 2), and reproduces the received video data to display video images on the display and output audio through the speaker. The state where the image is outputted to the display and the audio is outputted from the speaker can be referred to as “the video data is played”. The viewer-side UI control unit 202 is also connected to input means (not shown in FIG. 2) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and information obtained from the server 10. The input information transmission unit 206 transmits the user input obtained by the viewer-side UI control unit 202 to the server 10 over the network NW.

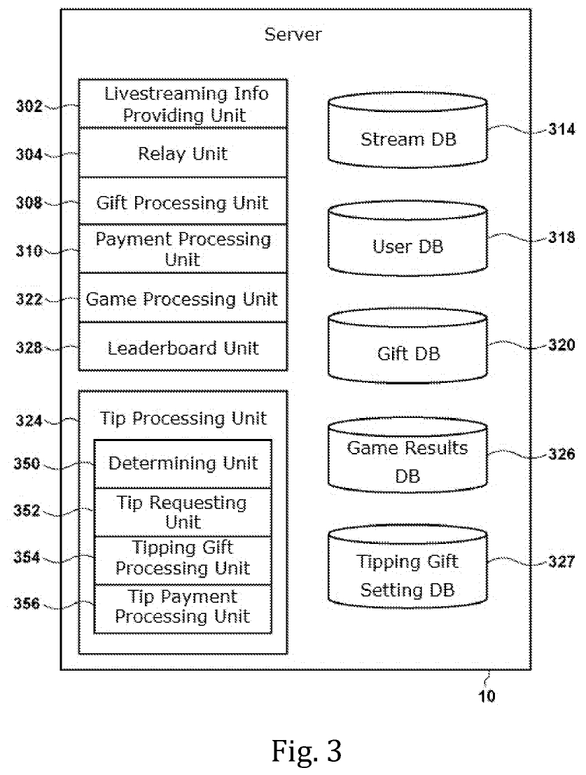

FIG. 3 is a block diagram showing functions and configuration of the server of FIG. 1. The server 10 includes a livestreaming information providing unit 302, a relay unit 304, a gift processing unit 308, a payment processing unit 310, a stream DB 314, a user DB 318, a gift DB 320, a game processing unit 322, a tip processing unit 324, a leaderboard unit 328, a game results DB 326 and a tipping gift setting DB 327. The server 10 is configured to provide games.

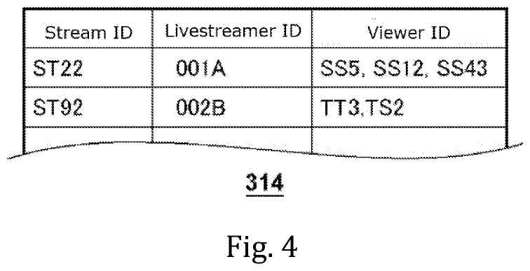

FIG. 4 is a data structure diagram of an example of the stream DB 314 of FIG. 3. The stream DB 314 holds information regarding a livestream currently taking place. The stream DB 314 stores a stream ID for identifying a livestream on a livestreaming platform provided by the livestreaming system 1, a livestreamer ID, which is a user ID for identifying the livestreamer who provides the livestream, and a viewer ID, which is a user ID for identifying a viewer of the livestream, in association with each other. In the livestreaming platform provided by the livestreaming system 1 of the embodiment, when a user livestreams, the user becomes a livestreamer, and when the same user views a livestream broadcast by another user, the user also becomes a viewer. Therefore, the distinction between a livestreamer and a viewer is not fixed, and a user ID registered as a livestreamer ID at one time may be registered as a viewer ID at another time.

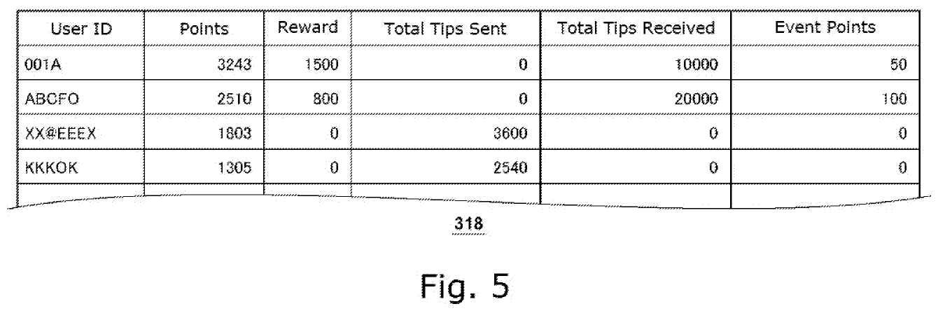

FIG. 5 is a data structure diagram showing an example of the user DB 318 of FIG. 3. The user DB 318 holds information regarding users. The user DB 318 stores a user ID for identifying a user, points held by the user, a reward given to the user, total amount of tipping gifts sent by the user, total amount of tipping gifts received by the user, and event points given to the user, in association with each other. The point is the electronic value circulated within the livestreaming platform. Users are able to purchase points by credit card or other means of payment. A reward is used to determine the amount of money a livestreamer receives from the administrator of the livestreaming platform. On the livestreaming platform, when viewers give gifts to the livestreamer during or after his/her livestream, the viewer's points are consumed and the livestreamer's reward is increased by a corresponding amount.

The tipping gift is a gift a viewer presents to a livestreamer when the viewer wins in a game which is played in a livestream of the livestreamer. The viewer is asked to present the tipping gift to the livestreamer if the total outcome or profit the viewer gained from the game(s) in the livestream exceeds a tip threshold. The total amount of tipping gifts may be calculated for a predetermined period, such as a month, a week or a day.

The event points are points given to the livestreamer in relation to an event. The event points can be obtained only by receiving an event gift from a viewer. In this embodiment, the event gift is available only when the total outcome or profit the viewer gained from the game(s) in the livestream exceeds a tip threshold.

The event specifies a certain period in time. Livestreamers participating in the event are evaluated by event points they earned in the certain period. Higher ranked livestreamers may receive special prizes.

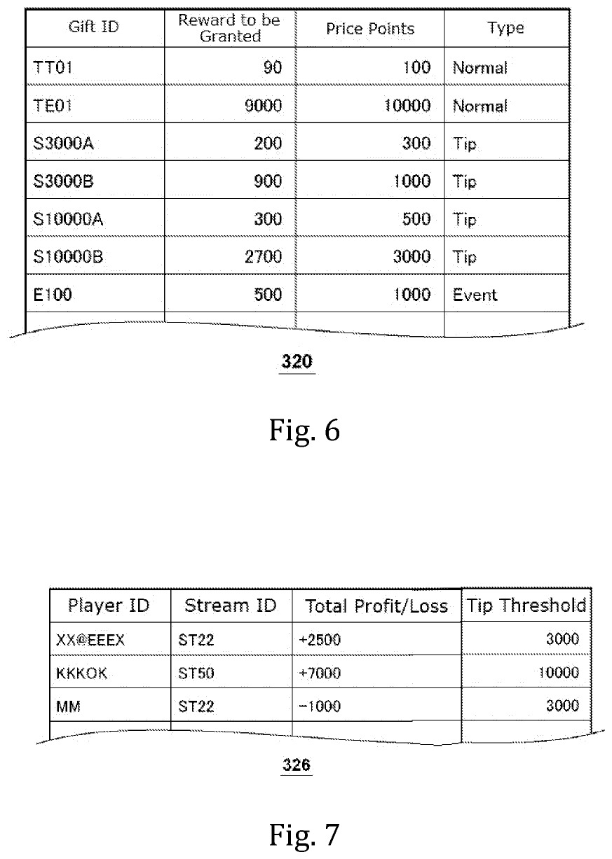

FIG. 6 is a data structure diagram showing an example of the gift DB 320 of FIG. 3. The gift DB 320 holds information regarding gifts available for the viewers in the livestreaming. A gift is electronic data with the following characteristics:
It can be purchased in exchange for the points or money, or can be given for free.
   It can be given by a viewer to a livestreamer.—Giving a gift to a livestreamer is also referred to as using the gift or throwing the gift.
   Some gifts may be purchased and used at the same time, and some gifts may be purchased and then used at any time later by the purchaser viewer.
   When a viewer gives a gift to a livestreamer, the livestreamer is given a corresponding reward.
   When a gift is used, the use may trigger an effect associated with the gift. For example, an effect corresponding to the gift will appear on the livestreaming room screen.

The gift DB 320 stores a gift ID for identifying a gift, a reward to be granted, which is a reward given to a livestreamer when the gift is given to the livestreamer, price points, which is the amount of points to be paid for use of the gift, and a type of the gift, in association with each other. A viewer is able to give a desired gift to a livestreamer by paying the price points of the desired gift while viewing the livestream. The payment of the price points may be made by an appropriate electronic payment means. For example, the payment may be made by the viewer paying the price points to the administrator. Alternatively, bank transfers or credit card payments may be used. The administrator is able to desirably set the relationship between the reward to be granted and the price points. For example, it may be set as the reward to be granted=the price points. Alternatively, points obtained by multiplying the reward to be granted by a predetermined coefficient such as 1.2 may be set as the price points, or points obtained by adding predetermined fee points to the reward to be granted may be set as the price points.

The type of gifts indicates whether the gift is a normal gift, a tipping gift or an event gift. The normal gift can be used anytime during a livestream, except for the timing when a tipping request happens. The tipping gift can be used anytime during a livestream, including the timing when the tipping request happens. The event gift can be used only when the tipping request happens. In other embodiments, the tipping gift can be set to be usable only when the tipping request happens.

Because a viewer can send a desired livestreamer the event gift only when the viewer is allowed to send the tipping gifts, the viewer, who would like the desired livestreamer to win in the event, tends to play the game many times to obtain the opportunity to send the event gift. This helps to make the game more popular and to strengthen the connection between the viewer and the livestreamer.

FIG. 7 is a data structure diagram showing an example of the game results DB 326 of FIG. 3. The game results DB 326 keeps track of the game status of each viewer who currently is playing the game. The game results DB 326 stores a player ID for identifying a viewer who currently is playing the game, a stream ID for identifying a livestream in which the viewer is playing the game, total profit/loss of the viewer in the game, and tip threshold for the viewer, in association with each other. The total profit/loss is a value obtained by summing up profits and losses of points as results of game-plays by a viewer in a predetermined time, in this case in a period of time from when the viewer started the game in the livestream to present. If the total profit/loss is plus, the total profit/loss can be said to be points obtained by a viewer in the game.

An example of the total profit/loss is: the viewer wins the game by +1000 points then the viewer loses in the next game by −500, then the total profit/loss of the viewer in the game is 1000−500=+500. Another example is that: the viewer wins the game by +300 then the viewer loses in the next game by −1500, then the total profit/loss of the viewer in the game is 300−1500=−1200. The total profit/loss of the viewer will be reset if the viewer quits or leaves the game in the livestream.

The tip threshold of the viewer is updated when the total profit/loss of the viewer hits the tip threshold. Candidate threshold values are pre-defined in the system, such as 3000, 10000, 30000, 100000.

In the example in FIG. 7, the first entry indicates that a viewer “XX@EEEX” is playing a game within a livestream “ST22,” that the total profit/loss is +2500 points, and that the tip threshold is 3000 points.

In the above embodiment, since the concept is to encourage viewers/players to share their lucky with livestreamers/streamers, the viewers are assumed to send the full price tipping gift to livestreamers. In other embodiments, a normal gift with the limited discount option may be set as a tipping gift. In this case, a popup dialogue is shown and includes a special discount gift with limited time period (ex: 10 seconds) to give the viewers more incentives to send the tipping gifts. For example, a normal gift “TE01” in FIG. 6 may be available with 9000 pts (10% discount) in the popup dialogue for tipping.

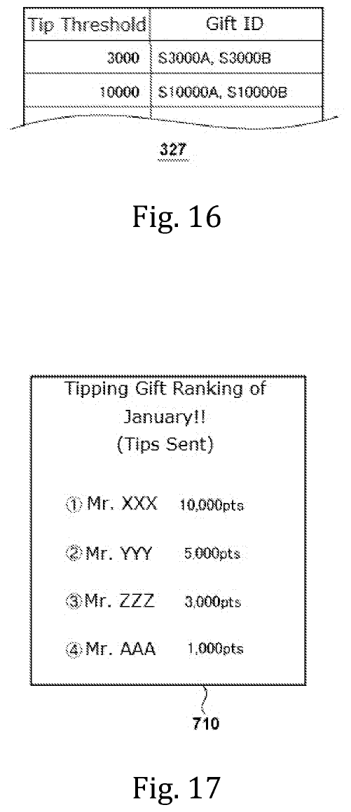

FIG. 16 is a data structure diagram showing an example of the tipping gift setting DB 327 of FIG. 3. The tipping gift setting DB 327 holds a plurality of different tip thresholds set by an administrator. The tipping gift setting DB 327 holds a tip threshold and a gift ID identifying a tipping gift having a price corresponding to the tip threshold, in association with each other. In the present embodiment, as the tip threshold increases, the price of the corresponding tipping gift increases.

Referring again to FIG. 3, upon reception of a notification from the user terminal 20 on the livestreamer side that the livestreamer starts a livestream over the network NW, the livestreaming information providing unit 302 registers a stream ID for identifying this livestream and the livestreamer ID of the livestreamer who performs the livestream in the stream DB 314. When the livestreaming information providing unit 302 receives a request to provide information about livestreams from the viewing unit 200 of the user terminal 30 on the viewer side over the network NW, the livestreaming information providing unit 302 retrieves currently available livestreams from the stream DB 314 and makes a list of the available livestreams. The livestreaming information providing unit 302 transmits the generated list to the requesting user terminal 30 over the network NW. The viewer-side UI control unit 202 of the requesting user terminal 30 generates a livestream selection screen based on the received list and displays it on the display of the user terminal 30.

Once the input information transmission unit 206 of the user terminal 30 receives the viewer's selection result of the livestream on the livestream selection screen, the input information transmission unit 206 generates a livestreaming request including the stream ID of the selected livestream, and transmits the request to the server 10 over the network NW. The livestreaming information providing unit 302 starts providing, to the requesting user terminal 30, the livestream specified by the stream ID included in the received livestreaming request. The livestreaming information providing unit 302 updates the stream DB 314 to include the user ID of the viewer of the requesting user terminal 30 into the viewer IDs of the stream ID.

The relay unit 304 relays the video data from the livestreamer-side user terminal 20 to the viewer-side user terminal 30 in the livestreaming started by the livestreaming information providing unit 302. The relay unit 304 receives from the input information transmission unit 206 a signal that represents user input by a viewer during the livestream or reproduction of the video data. The signal that represents user input may be an object specifying signal for specifying an object displayed on the display of the user terminal 30, and the object specifying signal includes the viewer ID of the viewer, the livestreamer ID of the livestreamer of the livestream that the viewer watches, and an object ID that identifies the object. When the object is a gift, the object ID is the gift ID. Similarly, the relay unit 304 receives from the distribution unit 100 of the user terminal 20 a signal that represents user input performed by the livestreamer during reproduction of the video data, such as the object specifying signal.

When the relay unit 304 receives a livestream viewing stop signal indicating that a viewer has stopped viewing the livestream from the user terminal 30 of the viewer, it stops transmission of video related to the livestream to the user terminal 30 from which the signal has transmitted. The livestream viewing stop signal includes the viewer ID of the viewer and the stream ID of the livestream that the viewer has stopped watching. The relay unit 304 also updates the stream DB 314 so that the viewer ID included in the received livestream viewing stop signal is removed from the viewer IDs stored in the stream DB 314.

The gift processing unit 308 updates the user DB 318 so as to increase the reward of the livestreamer depending on a reward to be granted by the gift identified by the gift ID included in the object specifying signal. Specifically, the gift processing unit 308 refers to the gift DB 320 to specify a reward to be granted by the gift ID included in the received object specifying signal. The gift processing unit 308 then updates the user DB 318 to add the determined reward to be granted to the reward of the livestreamer ID included in the object specifying signal.

The payment processing unit 310 processes payment of a price of a gift by a viewer in response to reception of the object specifying signal. Specifically, the payment processing unit 310 refers to the gift DB 320 to specify the price points of the gift identified by the gift ID included in the object specifying signal. The payment processing unit 310 then updates the user DB 318 to subtract the specified price points from the points of the viewer identified by the viewer ID included in the object specifying signal.

The game processing unit 322 performs processes related to provision of a game in a livestream. The game processing unit 322 performs processes related to the game played by a viewer in an on-going livestream. Specifically, the game processing unit 322 is configured to provide a game to a user terminal 30 of a viewer of a livestream via the network NW.

The game processing unit 322 uses the game results DB 326 to manage information relating to games. The game processing unit 322 receives a request for participation in a game (hereinafter referred to as “game participation request”) from the user terminal 30 of the viewer of the livestream via the network NW The viewer starts watching the livestream. While watching the livestream, the viewer inputs into the user terminal 30 an instruction to start a game. On reception of the instruction, the viewer-side communication unit 204 of the user terminal 30 generates a game participation request including the streamer ID indicative of the livestreamer of the livestream the viewer is watching, and transmits the game participation request to the server 10 over the network NW. The game processing unit 322 receives the game participation request so transmitted.

In response to the reception of the game participation request, the game processing unit 322 starts providing the game within the livestream to the user terminal 30 of the requesting viewer. The game processing unit 322 registers the user ID of the requesting viewer and the stream ID of the livestream the viewer is watching as the player ID and stream ID, respectively, in the game results DB 326.

The game processing unit 322 registers in the game results DB 326 the result of the game played by the viewer. If the viewer (player) wins the game, the game processing unit 322 updates the game results DB 326 such that the points gained from the victory are added to the viewer's total profit/loss. At the same time, the game processing unit 322 updates the user DB 318 such that the points gained from the victory are added to the viewer's points. If the viewer loses the game, the game processing unit 322 updates the game results DB 326 such that the points lost due to the defeat are subtracted from the viewer's total profit/loss. At the same time, the game processing unit 322 updates the user DB 318 such that the points lost due to the defeat are subtracted from the viewer's points.

In this embodiment, the game is a single-player game where the viewer chooses one element out of a plurality of elements with some bets. The game processing unit 322 performs a draw of one element out of the plurality of elements according to predetermined probability. If the element chosen by the viewer is drawn, then the viewer wins; otherwise, the viewer loses. Each element is associated with respective odds (multiplication factor). The viewer, if it wins, receives pay-back points amounting to (bet points) times (odds). There is no pay-back if the viewer loses. The higher the odds of an element are, the lower the probability of the element being drawn is. The game may, for example, be realized by the technology disclosed in FayBlog, “How To Get Diamonds in Uplive! Also Talk About Mini-Games!”, URL:https://fayevery.blog/uplive-diamond #index_id6.

While the single-player game is played in a livestream in this embodiment, the present disclosure is not limited to this. The technical concept disclosed in this disclosure may be applied to any type of game playable in a livestream, such as match type games or multiplayer game. For example, the tipping gift mechanism disclosed in this specification may be applied to a game in which a plurality of viewers compete each other, a game in which one or more viewers fight against a livestreamer (ex. blackjack, poker, rock-paper-scissors), a game in which a plurality of livestreamers compete each other, or a game in which a plurality of livestreamers and a plurality of viewers compete each other.

The single-player game is a game in which the livestreamer of the livestream does not participate. Due to its nature, the single-player game does not create much interaction between the viewer, who plays the game, and the livestreamer, who provides the game. It is thus highly expected that the tipping gift relating to the present embodiment will facilitate the viewer-livestreamer interaction.

The tip processing unit 324 performs processes related to tipping gifts. The tip processing unit 324 includes a determining unit 350, a tip requesting unit 352, a tipping gift processing unit 354, and a tip payment processing unit 356.

The determining unit 350 determines whether or not the points gained by the viewer in the game within the livestream satisfy a predetermined tip request generation condition. The following presents examples of the tip request generation condition.
(1) Total profit/loss exceeds a tip threshold.
(2) Points gained from a single win exceed a threshold, for example, the viewer wins at high odds.
(3) Total points gained from victories exceed a threshold (Points lost due to defeats do not count).

The present embodiment employs the example (1). The tip request generation condition is satisfied if the total profit/loss exceeds a tip threshold.

The determining unit 350 consults the game results DB 326 to determine, for each player, whether or not the tip request generation condition is satisfied. The determining unit 350 compares the total profit/loss against the tip threshold for each entry (each player) in the game results DB 326. The determining unit 350 determines that the tipping request generation condition is satisfied for a player if his/her total profit/loss exceeds his/her tip threshold.

If the determining unit 350 determines that the tip request generation condition is satisfied, the tip requesting unit 352 generates a tipping request and transmits the generated tipping request to the user terminal 30 of the viewer via the network NW. The tipping request is configured to allow the user terminal 30 of the viewer to start receiving an instruction to use a tipping gift to the livestreamer. If the total profit/loss of the player is determined to exceed the tip threshold and the tip request generation condition is thus determined to be satisfied, the tip requesting unit 352 refers to the game results DB 326 to identify the user ID of the player and the tip threshold. In addition, the tip requesting unit 352 refers to the tipping gift setting DB 327 to retrieve a next and higher tip threshold. The tip requesting unit 352 replaces the identified tip threshold with the retrieved tip threshold in the game results DB 326. For example, if the total profit/loss of the player “XX@EEEX” exceeds the tip threshold “3000,” the tip requesting unit 352 refers to the tipping gift setting DB 327 to identify the next tip threshold “10000,” which is higher than the current tip threshold “3000.” The tip requesting unit 352 updates the game results DB 326 such that the tip threshold “3000” of the player “XX@EEEX” is replaced with the identified tip threshold “10000.”

The tip requesting unit 352 identifies a tipping gift having a price corresponding to the tip threshold exceeded by the total profit/loss. The tip requesting unit 352 refers to the tipping gift setting DB 327 to identify the gift IDs of the tipping gifts associated with the identified tip threshold. The tip requesting unit 352 refers to the gift DB 320 to identify gift IDs of event gifts.

The tip requesting unit 352 generates a tipping request including the identified gift IDs. The tip requesting unit 352 transmits, to the user terminal 30 of the viewer identified by the identified user ID, the generated tipping request over the network NW.

If the user terminal 30 receives an instruction to use a tipping gift, the tipping gift processing unit 354 updates the user DB 318 such that the livestreamer's reward increases by an amount corresponding to the reward to be given by the used tipping gift. When the user terminal 30 receives the instruction to use a tipping gift, the user terminal 30 generates an object designation signal (hereinafter referred to as “a tipping response”) including, as the object ID, the gift ID of the tipping gift designated by the viewer and transmits the generated object designation signal to the server 10. On reception of the tipping response, the tipping gift processing unit 354 refers to the gift DB 320 to identify a reward to be given that is associated with the used tipping gift (in other words, the tipping gift identified by the gift ID included in the tipping response). The tipping gift processing unit 354 updates the user DB 318 such that the identified reward to be given is added to the reward associated with the livestreamer to whom the tipping gift is given (in other words, the livestreamer identified by the livestreamer ID included in the tipping response).

If the user terminal 30 receives the instruction to use a tipping gift, the tipping gift processing unit 354 registers in the user DB 318 the information regarding the use of the tipping gift. Upon receipt of the tipping response, the tipping gift processing unit 354 updates the user DB 318, such that the price of the tipping gift is added to the value of “Total Tips Sent” associated with the giver of the used tipping gift (i.e., the viewer identified by the viewer ID included in the tipping response) and the price of the tipping gift is added to the value of “Total Tips Received” associated with the recipient of the tipping gift. Referring now to the example shown in FIGS. 5 and 6, if the viewer “XX@EEEX” uses the tipping gift “S3000B” for the livestreamer “001A”, the tipping gift processing unit 354 changes the values stored in the user DB 318 such that the value of “Total Tips Sent” in the entry associated with the user ID “XX@EEEX” is changed from “3600” to “4600”, and the value of “Total Tips Received” in the entry associated with the user ID “001A” is changed from “10,000” to “11,000”.

If the user terminal 30 receives the instruction to use a tipping gift, the tipping gift processing unit 354 transmits an effect output request to the user terminal 20 of the livestreamer and the user terminals of the other viewers via the network NW. The effect output request is configured to cause an effect for the tipping gift to be output outside the user interface of the game. On reception of the tipping response, the tipping gift processing unit 354 refers to the stream DB 314 to identify other viewers who are currently watching the livestream of the livestreamer to whom the tipping gift is sent. The tipping gift processing unit 354 generates the effect output request including the gift ID of the used tipping gift and transmits the effect output request to the user terminal 20 of the livestreamer to whom the tipping gift is sent and the user terminals of the identified other viewers over the network NW The user terminals that have received the effect output request show the effect of the tipping gift identified by the gift ID included in the received request on the display in a region outside the user interface of the game.

If the user terminal 30 receives an instruction to use an event gift, the tipping gift processing unit 354 updates the user DB 318 such that the livestreamer's reward increases by an amount corresponding to the reward to be given by the used event gift. If the user terminal 30 receives the instruction to use an event gift, the user terminal 30 generates an object designation signal including as the object ID the gift ID of the event gift designated by the viewer (hereinafter, referred to as “event gift usage signal”) and transmits the event gift usage signal to the server 10. On reception of the event gift usage signal, the tipping gift processing unit 354 refers to the gift DB 320 to identify the reward to be given that is associated with the used event gift (in other words, the event gift identified by the gift ID included in the event gift usage signal). The tipping gift processing unit 354 updates the user DB 318 such that the identified reward to be given is added to the reward associated with the livestreamer to whom the event gift is given (in other words, the livestreamer identified by the livestreamer ID included in the event gift usage signal).

If the user terminal 30 receives the instruction to use an event gift, the tipping gift processing unit 354 registers in the user DB 318 the information regarding the use of the event gift. On reception of the event gift usage signal, the tipping gift processing unit 354 updates the user DB 318 such that the event points associated with the event gift are added to the value of “Event Points” associated with the livestreamer to whom the used event gift is sent.

The tip payment processing unit 356 processes payment of the price of the tipping gift by the viewer in response to reception of the tipping response. Specifically, the tip payment processing unit 356 refers to the gift DB 320 to identify the price points of the tipping gift identified by the gift ID included in the tipping response. The tip payment processing unit 356 updates the user DB 318 such that the identified price points are subtracted from the points of the viewer identified by the viewer ID included in the tipping response. For the event gift, the payment is processed in the same manner.

The leaderboard unit 328 refers to the user DB 318 to generate a leaderboard that ranks the livestreamers according to the tipping gifts sent to them and/or a leaderboard that ranks the viewers according to the tipping gifts they send. The leaderboard unit 328 performs processes related to generation, maintenance and provision of leaderboards. The leaderboard unit 328 refers to the user DB 318 to generate a total-tip-sent leaderboard and a total-tip-received leaderboard. The leaderboard unit 328 stores the generated leaderboards into a leaderboard DB (not shown in the drawings), so that the leaderboards can be provided to the user terminal 20 of the livestreamer or the user terminal 30 of the viewer per request. The leaderboard unit 328 refers to the user DB 318 to generate an event leaderboard according to event points. The leaderboard unit 328 stores the generated event leaderboard into the leaderboard DB (not shown in the drawings), so that the event leaderboard can be provided to the user terminal 20 of the livestreamer or the user terminal 30 of the viewer per request. In this embodiment, the total-tip-sent leaderboard is generated regardless of to whom the tipping gifts are sent. In some embodiments, the leaderboard unit 328 may generate a total-tip-sent leaderboard for a target livestreamer. The leaderboard ranks viewers according to the amount of tipping gifts the viewers send to the target livestreamer.

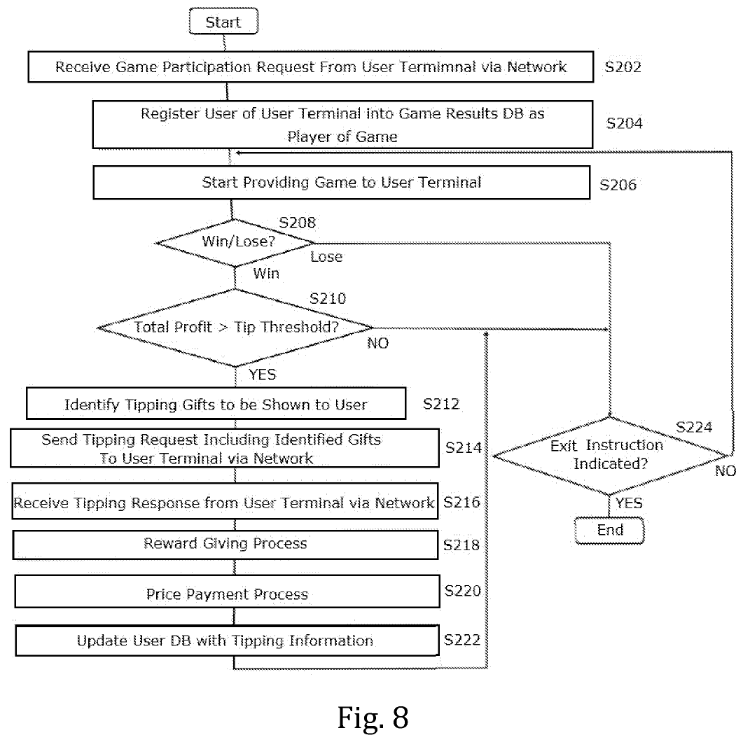

FIG. 8 is a flow chart of the processes performed in the livestreaming system 1 when a viewer plays a game in a livestream. The viewer taps on a game object displayed in a livestreaming room screen on the display of the user terminal of the viewer. The viewer-side UI control unit 202 detects the tapping on the game object. The input information transmission unit 206, in response to detecting the tapping, generates a game participation request including the viewer ID of the viewer and the stream ID of the livestream which the viewer is viewing. The game participation request is a type of the object specifying signal. The input information transmission unit 206 sends, via the network NW, the generated game participation request to the server 10. The game processing unit 322 receives the game participation request from the user terminal of the viewer via the network NW (step S202).

The game processing unit 322 registers the viewer of the requesting user terminal into the game results DB 326 as a player of the game (step S204). The unit 322 creates a new entry in the DB 326 and fill it with the viewer ID included in the received request as the player ID and with the stream ID included in the received request as the stream ID. The game processing unit 322 starts providing the game to the requesting user terminal via the network NW (step S206). The viewer of the requesting user terminal plays the game. The game processing unit 322 determines whether the viewer wins or loses in the game (step S208).

The game processing unit 322 updates the game results DB 326 and the user DB 318 with the results of the game played by the viewer at the step S208. For example, if the viewer wins in the game and received +300 points as a result of the game, the unit 322 updates the user DB 318 so that the received points 300 is added to the points of the viewer who won the game. The unit 322 further updates the game results DB 326 so that the received points 300 is added to the total profit/loss of the viewer who won the game.

If the viewer wins at the step S208, the tip processing unit 324 determines, by referring to the game results DB 326, whether the total profit/loss of the viewer exceeds the tip threshold (step S210). If exceeds (YES at step S210), the unit 324 identifies tipping gifts to be shown to the user (step S212). The unit 324 identifies the tip threshold which is exceeded at step S210. The unit 324 identifies, by referring to the tipping gift setting DB 327, tipping gifts which correspond to the identified tip threshold. For example, if the tip threshold “3000” is identified, the unit 324 identifies tipping gifts “S3000A”, “53000B” and the event gift “E100”. If the tip threshold “10000” is identified, the unit 324 identifies tipping gifts “S10000A”, “S10000B” and the event gift “E100”. The correspondence between the tip threshold and the tipping gifts may be predefined by the operator of the livestream platform. The correspondence may be set so that the greater the tip threshold is, the higher the price points of the tipping gift is. In some embodiments, there may be a tipping gift common to a plurality of tip thresholds. The event gift “E100” is an example of such common tipping gift. In some embodiments, the price points of a tipping gift may be input or determined by the viewer.

The unit 324 updates the game results DB 326 so that the tip threshold which is determined to be exceeded at the step S210 increases to the next higher value. For example, if the tip threshold “3000” is exceeded at the step S210, the unit 324 replaces the tip threshold “3000” with the next tip threshold “10000” in the game results DB 326.

The tip processing unit 324 generates a tipping request including the gift IDs which are identified at the step S212. The unit 324 sends, via the network NW, the generated tipping request to the user terminal of the viewer whose total profit/loss is determined to exceed the tip threshold at the step S210 (step S214). The viewer, by looking at a tip request region displayed on the display of the user terminal, decides to give a tipping gift or an event gift to the livestreamer. The viewer taps on one of the gift objects corresponding to the gift IDs included in the tipping request. The viewer-side UI control unit 202 detects the tapping on the gift object. The input information transmission unit 206, in response to detecting the tapping, generates a tipping response including the gift ID of the tapped gift object. The tipping response is a type of the object specifying signal. The input information transmission unit 206 sends, via the network NW, the generated tipping response to the server 10. The tip processing unit 324 receives the tipping response from the user terminal of the viewer via the network NW (step S216).

The tip processing unit 324 performs a reward giving process based on the received tipping response (step S218). The reward giving process has already been explained earlier. The unit 324 performs a price payment process based on the received tipping response (step S220). The price payment process has already been explained earlier. The tip processing unit 324 updates the user DB 318 with tipping information (step S222). The unit 324 adds the price points of the tipping gift or the event gift given by the viewer to the total tips received by the livestreamer of the livestream which the viewer is viewing. The unit 324 adds the price points of the tipping gift or the event gift given by the viewer to the total tips sent by the viewer. The unit 324 adds the price points of the event gift given by the viewer to the event points of the livestreamer of the livestream which the viewer is viewing.

When the viewer loses in the game (Lose at step S208), or when the total profit/loss does not exceed the tip threshold (NO at step S210), or after the step S222, the game processing unit 322 determines whether an exit instruction is indicated by the viewer or not (step S224). The exit instruction is generated at the user terminal and sent to the server 10 if the viewer quits the game at the user terminal. If indicated (YES at step S224), the process ends. If not indicated (NO at step S224), the process goes back to the step S206 to start a new round of the game.

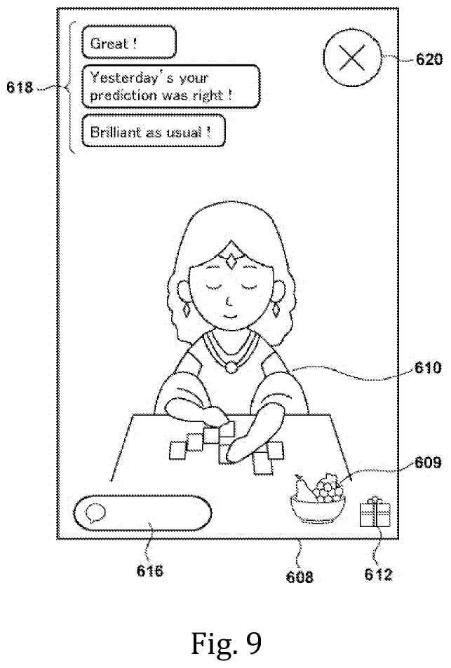

FIG. 9 is a representative screen image of the livestreaming room screen 608 shown on the display of the viewer user terminal 30. The livestreaming room screen 608 displays a video image generated by the user terminal 20 of the livestreamer in real time. The livestreaming room screen 608 includes a video image 610 of a livestreamer obtained by reproducing the video data received from the server 10, a gift object 612, a comment input region 616, a comment display region 618, a game object 609 and a quit viewing button 620. The superimposed information generation unit 204 superimposes objects such as the gift object 612, the comment input region 616, the comment display region 618, the game object 609, and the quit viewing button 620 on the video image 610 obtained by reproducing the video data by the viewer-side UI control unit 202 to generate the livestreaming room screen 608.

The comment display region 618 may include a comment entered by the viewer and comments entered by other viewers, and notifications from the system. The notifications from the system include information on who gave which gift to the livestreamer. The superimposed information generation unit 204 generates the comment display region 618 including comments of other viewers and received from the server 10 and notifications from the system, and the viewer-side UI control unit 202 includes the generated comment display region 618 in the livestreaming room screen 608.

The comment input region 616 accepts comment inputs by the viewer. The input information transmission unit 206 generates a comment input signal that includes the comment entered in the comment input region 616, and transmits the signal to the server 10 over the network NW. At the same time, the superimposed information generation unit 204 updates the comment display region 618 to display the comment entered in the comment input region 616.

The quit viewing button 620 is an object for accepting an instruction from the viewer to quit viewing the livestream.

The gift object 612 is an object for allowing the viewer to send a gift to the livestreamer.

The game object 609 is an object to receive an instruction to participate in a game from the viewer while the viewer is watching the livestream.

The viewer taps the game object 609 while watching the livestream. On detection of the tap on the game object 609, the viewer-side UI control unit 202 of the user terminal 30 treats the tap as an instruction to participate in a game. On reception of the instruction, the input information transmission unit 206 of the user terminal 30 generates the above-described game participation request and transmits the game participation request to the server 10 over the network NW. In response to the reception of the game participation request, the tip processing unit 324 of the server 10 starts providing the game to the user terminal 30 of the viewer. The superimposed information generation unit 204 of the user terminal 30 generates a game region 622 based on the received game data. The superimposed information generation unit 204 superimposes the generated game region 622 on the livestream room screen 608.

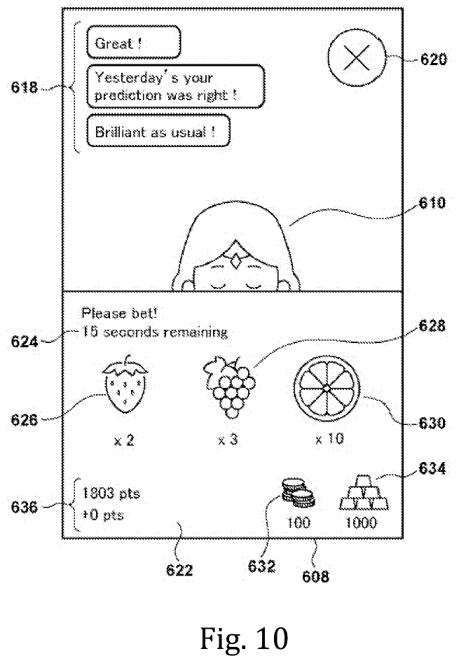

FIG. 10 is a representative screen image of the livestream room screen 608 on which the game region 622 is superimposed on the display of the viewer's user terminal 30. The game region 622 is a popup dialog superimposed on the livestream room screen 608. The game region 622 has a remaining time region 624 showing the time remaining in a current round of the game, three different elements 626, 628, 630 respectively associated with corresponding odds, a low bet object 632, a high bet object 634, and a point display region 636 showing the points currently owned by the viewer, who is the player, and the current total profit/loss for that viewer.

The viewer taps one of the three elements 626, 628 and 630 to bet some points on the tapped element. Alternatively, the viewer may drag and drop the low bet object 632 or high bet object 634 on a desired one of the elements to bet some points on the desired element. Upon expiration of the duration of the current round of the game, the game processing unit 322 draws lots to determine the winning element from the three elements 626, 628 and 630.

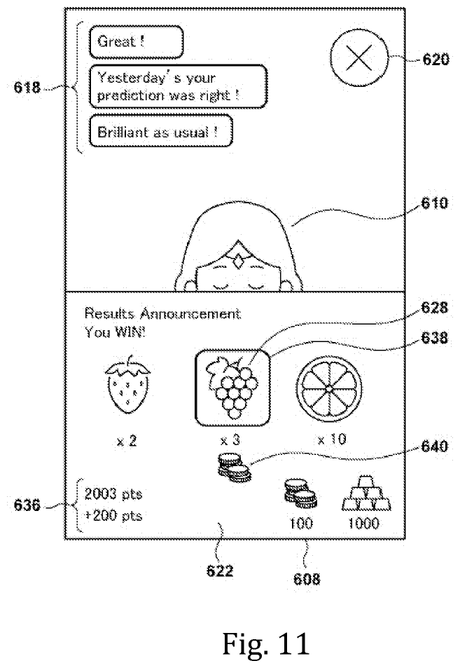

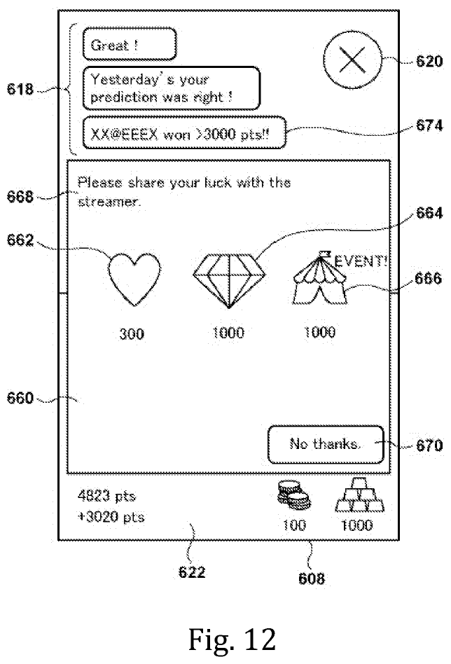

FIG. 11 is a representative screen image of the livestream room screen 608 on which the game region 622 is superimposed on the display of the viewer's user terminal 30. FIG. 12 shows the case where the viewer has won in the round of the game shown in FIG. 11. The viewer makes a bet by dragging and dropping the low bet object 632 on the element 628 (grape), and the game processing unit 322 draws lots to determine the element 628 as the winning element. In the game region 622, an object 640 indicates the viewer's bet, and a frame 638 indicates the winning element 628. The game processing unit 322 determines that the viewer has won at odds of 3 and performs necessary processes (e.g., updates the user DB 318) to refund (−100)+(100×3)=+200 points to the viewer. The point display region 636 in FIG. 11 reflects the results of the refund.

If the total profit/loss of the viewer reflecting the result of the game provided through the game region 622 shown in FIG. 11 exceeds the tip threshold, the user terminal 30 of the viewer starts receiving an instruction to use a tipping gift to the livestreamer. More specifically, the user terminal 30 generates a tip request region 660 and presents the tip request region 660 to the viewer. The tip request region 660 is configured to inquire the viewer if the viewer intends to use a tipping gift having price points corresponding to the tip threshold exceeded by the total profit/loss.

FIG. 12 is a representative screen image of the livestreaming room screen 608 with the tip request region 660, shown on the display of the viewer user terminal 30. If the total profit/loss of the viewer in the game exceeds the tip threshold, the user terminal 30 receives the tipping request from the server 10. The user terminal 30 then generates the tip request region 660 based on the received tipping request and has the tip request region 660 displayed on top of the livestreaming room screen 608 as a pop-up. The tip request region 660 has three gift objects 662, 664, 666, two (662, 664) of which correspond to tipping gifts and one (666) of which corresponds to the event gift. The viewer selects and taps on one of the three gift objects. The user terminal 30 generates a tipping response including a gift ID corresponding to the selected gift object and transmits the tipping response to the server 10. The tip request region 660 includes a message 668 recommending that the viewer's good luck be shared with the livestreamer. In association with the gift objects 662, 664 and 666, their price points are displayed. The tip request region 660 has a button 670 to close the region without giving a tipping gift. Since the tipping request includes the gift IDs of the tipping gifts having price points corresponding to the exceeded tip threshold, the tip request region 660 shows the gift objects indicative of the tipping gifts having price points corresponding to the exceeded tip threshold.

If the total profit/loss of the viewer reflecting the result of the game provided through the game region 622 of FIG. 11 exceeds the tip threshold, the user terminal 30 outputs, within the livestream, a message indicating that the viewer has satisfied the tip request generation condition. For the comment display region 618, the server 10 generates a system notification including a victory message 674 indicating that the viewer has won the game and that the viewer's total profit/loss has exceeded the tip threshold. The server 10 transmits the generated system notification to the user terminal 20 of the livestreamer and the user terminals 30 of all the viewers. The user terminal 30 of each viewer updates the comment display region such that the victory message 674 included in the received system notification may appear in the comment display region. The user terminal 20 of the livestreamer also updates the comment display region such that the victory message 674 included in the received system notification may appear in the comment display region. In other words, the victory message 674 appears not only in the comment display region 618 of the user terminal of the viewer whose total profit/loss has exceeded the tip threshold, but also in the comment display region of the user terminal of the livestreamer and in the comment display region of the user terminals of the other viewers. Therefore, they will know that the viewer won a lot. This will motivate the viewer to send the tipping gift to the livestreamer, because the viewer tends to think that he or she does not want to be seen as a stingy person.

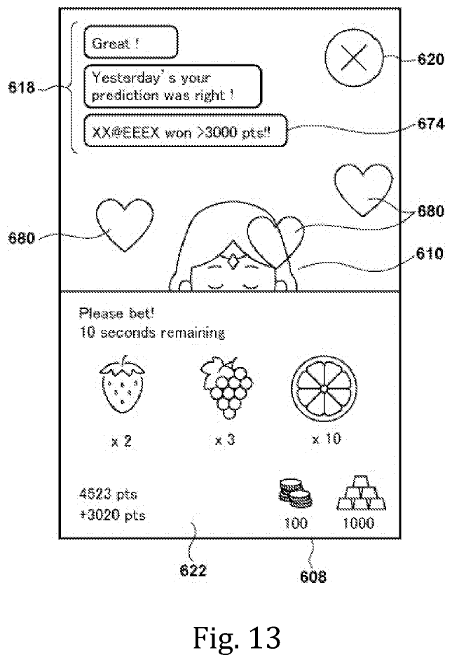

FIG. 13 is a representative screen image of a livestreaming room screen 608 with the game region 622 and tipping gift effects 680, shown on the display of the viewer user terminal 30. If a tipping gift is sent to the livestreamer, i.e., the viewer taps the gift object corresponding to the tipping gift in the tip request region 660 shown in FIG. 12, the user terminal 30 receives the instruction to use the tipping gift corresponding to the tapped gift object. On reception of the instruction, the user terminal 30 outputs the tipping gift effect 680 of the used tipping gift, within the livestreaming room screen 608 and outside the game region 622, which is the user interface of the game. In the example shown in FIG. 13, the tipping gift effect 680 is superimposed on the video image 610 of the livestreamer in the livestreaming room screen 608. The tipping gift effect 680 does not appear in the game region 622. In other words, the tipping gift effect 680 appears in a region of the livestreaming room screen 608 that is not occupied by the game region 622. The tipping gift effect 680 is similarly output at the user terminal of the livestreamer and the user terminals of the other viewers through the server 10. The tipping gift effect 680 is a visual and/or audio effect and generated at the user terminal 30. In the present embodiment, the tipping gift does not affect the progress of the game and is treated in the same manner as regular gifts in terms of its payment and effect. Stated differently, a path is provided in the game to allow the user to give a regular gift. In this respect, the present embodiment differs from the case where the viewer can intervene the game played by the livestreamer by sending an in-game gift to the livestreamer. The comment display region 618 may be updated with a further system notification stating that the viewer sends the tipping gift to the livestreamer.

FIG. 17 is a representative screen image of a leaderboard screen 710 displayed on the display of the viewer's user terminal 30. Based on the leaderboard information retrieved from the leaderboard DB, the user terminal 30 generates the leaderboard screen 710 and shows the generated screen on the display.

In the above embodiment, the DBs or holding unit may be implemented by, for example, hard disks or semiconductor memory. It is understood by those skilled in the art that each element or component can be realized by a CPU not shown, a module of an installed application program, a module of a system program, or a semiconductor memory that temporarily stores the contents of data read from a hard disk, and the like.

According to the livestreaming system 1 relating to the present embodiment, a game playable within a livestream and involving gaining and losing points is provided. If a player gains a profit by playing such a game and the profit satisfies a predetermined condition, the player is encouraged to give a tipping gift to the livestreamer. By sending a tipping gift, the player can share the luck with the livestreamer. This allows both the livestreamer and the player, who is the viewer, to enjoy the livestreaming more and to strengthen the connection between them.

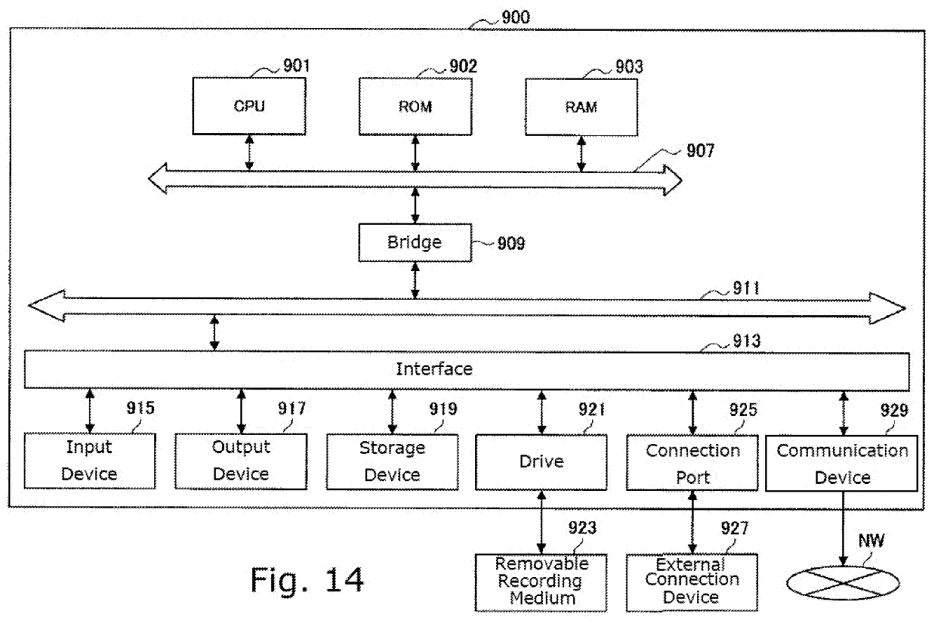

Referring to FIG. 14, the hardware configuration of the information processing device will be now described. FIG. 14 is a block diagram showing an example of a hardware configuration of the information processing device according to the embodiment. The illustrated information processing device 900 may, for example, realize the server 10 and the user terminals 20 and 30 in the embodiment.

The information processing device 900 includes a CPU 901, ROM (Read Only Memory) 902, and RAM (Random Access Memory) 903. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 902, the RAM 903, the storage device 919, or a removable recording medium 923. For example, the CPU 901 controls the overall operation of each functional unit included in the server 10 and the user terminals 20 and 30 in the embodiment. The ROM 902 stores programs, calculation parameters, and the like used by the CPU 901. The RAM 903 serves as a primary storage that stores a program used in the execution of the CPU 901, parameters that appropriately change in the execution, and the like. The CPU 901, ROM 902, and RAM 903 are interconnected to each other by a host bus 907 which may be an internal bus such as a CPU bus. Further, the host bus 907 is connected to the external bus 911 such as a PCI (Peripheral Component Interconnect/Interface) bus via the bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OLED, etc., a sound output device such as a speaker and headphones, and a printer. The output device 917 outputs the results of processing by the information processing device 900 as text, video such as images, or sound such as audio.

The storage device 919 is a device for storing data and configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for a removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 903. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is an imaging element such as a CCD (Charge Coupled Device) or CMOS (Complementary Metal Oxide Semiconductor), and a device that captures an image of the real space using various elements such as lenses for controlling image formation of a subject on the imaging element to generate the captured image. The image capturing device may capture a still image or may capture a moving image.

The configuration and operation of the livestreaming system 1 in the embodiment have been described. This embodiment is a merely example, and it is understood by those skilled in the art that various modifications are possible for each component and a combination of each process, and that such modifications are also within the scope of the present disclosure.

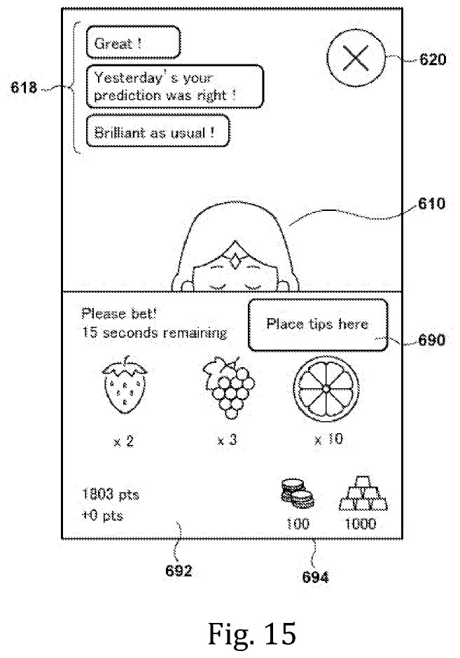

In the above embodiment, the tipping gift is sent through the tip request region 660; however, the present disclosure is not limited to this. For example, the game region superimposed on top of the livestream room screen may have a tip placement region dedicated for placing the tipping gifts. FIG. 15 is a representative screen image of a livestreaming room screen 694 with a game region 692 having a tip placement region 690, shown on the display of the viewer user terminal 30. The tip placement region 690 may start to be displayed when the total profit/loss of the viewer exceeds the tip threshold. Alternatively, the tip placement region 690 may always appear on the game region 692 to accept the tipping gifts anytime during the game. In either case, the viewer taps on the tip placement region 690 to send the tipping gift, or the viewer drags the bet object toward the tip placement region 690 and drops it onto the region 690. Then the tipping gift provision process as described earlier is performed. Alternatively, if the total profit/loss of the viewer exceeds the tip threshold, a gift object may appear in the game region. Tapping on the gift object may lead to the tip request region as shown in FIG. 12 or other gift selection popup dialogue.

In the above embodiment, the tipping request is generated and sent when the total profit/loss of the viewer exceeds the tip threshold; however, the present disclosure is not limited to this. For example, the tipping request may be generated and sent when the viewer wins in the game in a special manner, such as drawing 1:1000 odds. For example, if the profit or outcome from one game exceeds a threshold, a corresponding tipping request may be generated. In such a case, the server 10 may generate a system notification stating that the viewer won a lot. Alternatively, the tipping request may be generated when the viewer quits the game. The viewer indicates his/her will to quit the game on the user terminal. The user terminal generates game-quit request and sends it to the server 10. The tip processing unit, in response to receiving the game-quit request, generates the tipping request and sends it to the requesting user terminal. Alternatively, the server 10 regularly generates the tipping request for a viewer as long as the viewer keeps playing the game. In this case, the tipping request is generated regardless of the total profit/loss of the viewer. In this case, the tipping request may be generated every 10 minutes or every 10 rounds of the game.

In the above embodiment, the total profit/loss of a viewer is calculated from the results of the rounds of the game which the viewer plays in a livestream; however, the present disclosure is not limited to this. For example, results of rounds of the game which a viewer plays in a first livestream and results of rounds of the game which the same viewer plays in a second livestream may be summed up to obtain the total profit/loss of the viewer. The livestreamer of the first livestream may or may not be the same as the livestreamer of the second livestream.

In some embodiments, an expectation value or a winning probability for a viewer in the game may increase if the amount of tipping gifts the viewer sends increases.

In the above embodiment, the tipping gifts to be shown in the tip request region are selected according to the tip threshold, however, the present disclosure is not limited to this. For example, the greatest bet may be identified from the bets of the viewer and at least one of the tipping gifts to be shown in the tip request region may be selected according to the identified bet.

In the embodiment, if the total points spent by the viewer in the game exceeds the total points returned to the viewer, a digital item having a value equal to the difference in points may be given to the viewer.

The conversion rate from the points paid for the gift to the granted reward in the embodiment is merely example, and the conversion rate may be appropriately set by the administrator of the livestreaming system 1, for example.

The technical idea according to the embodiment may be applied to live commerce or virtual livestreaming using an avatar that moves in synchronization with the movement of the livestreamer instead of the image of the livestreamer.

The procedures described herein, particularly those described with a flow diagram, a flowchart, are susceptible of omission of part of the steps constituting the procedure, adding steps not explicitly included in the steps constituting the procedure, and/or reordering the steps. The procedure subjected to such omission, addition, or reordering is also included in the scope of the present invention unless diverged from the purport of the present invention.

At least some of the functions realized by the server 10 may be realized by a device(s) other than the server 10, for example, the user terminals 20 and 30. At least some of the functions realized by the user terminals 20 and 30 may be realized by a device(s) other than the user terminals 20 and 30, for example, the server 10. For example, the superimposition of a predetermined frame image on an image of the video data performed by the user terminal where the video data is reproduced may be performed by the server 10 or may be performed by the user terminal where the video data is generated.

What is claimed is:

1. A terminal of a viewer of a livestream, comprising:
one or more processors; and
memory storing one or more computer programs configured to be executed by the one or more processors,
the one or more computer programs including instructions for:
communicating over a network with a server configured to provide a game, the game being playable within a livestream and involving gaining or losing points; and
if points gained by the viewer by playing the game within the livestream satisfy a predetermined condition, starting to receive an instruction to use a gift to a livestreamer of the livestream.

2. The terminal of claim 1, wherein the predetermined condition is satisfied if a value obtained as a result of totaling gained and lost points exceeds a threshold.

3. The terminal of claim 2,
wherein a plurality of different thresholds are set, and each threshold is associated with a gift having a corresponding price, and
wherein the starting includes inquiring, if a value obtained as a result of totaling gained and lost points exceeds a threshold, the viewer whether the viewer uses a gift having a price corresponding to the exceeded threshold.

4. The terminal of claim 1, wherein the one or more computer programs further include instructions for
on reception of the instruction to use the gift, outputting an effect of the gift within the livestream and outside a user interface of the game.

5. The terminal of claim 1,
wherein the one or more computer programs further include instructions for outputting a message within the livestream if the points gained by the viewer by playing the game within the livestream satisfy the predetermined condition, the message indicating that the viewer has satisfied the predetermined condition, and
wherein the message is also output at a terminal of the livestreamer of the livestream and terminals of one or more other viewers.

6. The terminal of claim 1, wherein the livestreamer of the livestream does not participate in the game.

7. A method implemented at a terminal of a viewer of a livestream, the method comprising:
communicating over a network with a server configured to provide a game, the game being playable within a livestream and involving gaining or losing points; and
if points gained by the viewer by playing the game within the livestream satisfy a predetermined condition, starting to receive an instruction to use a gift to a livestreamer of the livestream.

8. The method of claim 7, wherein the predetermined condition is satisfied if a value obtained as a result of totaling gained and lost points exceeds a threshold.

9. The method of claim 8,
wherein a plurality of different thresholds are set, and each threshold is associated with a gift having a corresponding price, and
wherein the starting includes inquiring, if a value obtained as a result of totaling gained and lost points exceeds a threshold, the viewer whether the viewer uses a gift having a price corresponding to the exceeded threshold.

10. The method of claim 7, further comprises
on reception of the instruction to use the gift, outputting an effect of the gift within the livestream and outside a user interface of the game.

11. The method of claim 7, further comprises
outputting a message within the livestream if the points gained by the viewer by playing the game within the livestream satisfy the predetermined condition, the message indicating that the viewer has satisfied the predetermined condition, and
wherein the message is also output at a terminal of the livestreamer of the livestream and terminals of one or more other viewers.

12. The method of claim 7, wherein the livestreamer of the livestream does not participate in the game.

13. A server comprising:
a unit for providing a game to a terminal of a viewer of a livestream via a network, the game being playable within the livestream and involving gaining and losing points;
a unit for determining whether points gained by the viewer by playing the game within the livestream satisfy a predetermined condition;
a unit for, if the predetermined condition is determined to be satisfied, transmitting a request via the network to the terminal of the viewer, the request being configured to allow the terminal of the viewer to start receiving an instruction to use a gift for a livestreamer of the livestream; and
a unit for, when the instruction to use the gift is received, transmitting via the network a request to a terminal of the livestreamer and terminals of one or more other viewers, the request being configured to cause an effect of the gift to be output outside a user interface of the game.

14. The server of claim 13, further comprising:
a unit for, when the instruction to use the gift is received, registering in a holding unit information relating to the gift; and
a unit for consulting the holding unit to generate a leaderboard ranking livestreamers according to gifts sent to the livestreamers and/or a leaderboard ranking viewers according to gifts the viewers send.
